(19) United States
(12) Patent Application Publication
(10) Pub. No.: US 2006/0240163 A1
(43) Pub. Date: Oct. 26, 2006

(54) Low calorie, palatable sugar substitute with enhanced sweetness

(76) Inventors: Steven Catani, Athens, GA (US); John Leahy, North Wales, PA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/114,771

(22) Filed: Apr. 26, 2005

(51) Int. Cl. A23L 1/236

(52) U.S. Cl. 426/548

(57) ABSTRACT

The invention relates to a sweetening composition comprised of a high intensity sweetener in an amount sufficient to provide greater than about 10 grams of Sucrose Equivalent Sweetness, and a carrier in an amount sufficient to provide the sweetening composition with less than about 0.49 Calories per gram of Sucrose Equivalent Sweetness, as well as a kit comprised of a container and the sweetening composition, wherein the sweetening composition is held within the container prior to use.

### CROSS-REFERENCE TO RELATED APPLICATIONS

This application is related to the following applications, which were filed in the United States Patent Office on the same day hereof: “ENHANCING KIT FOR COMESTIBLE PRODUCTS” {Attorney Docket MSP 5025}; “KIT FOR PROVIDING SWEETENERS HAVING NON-STANDARD SWEETNESS LEVELS,” {Attorney Docket MSP 5027}; and “METHODS FOR PROMOTING COMESTIBLE PRODUCTS” {Attorney Docket MSP 5028}.

### BACKGROUND OF THE INVENTION

1. Field of the Invention

This invention relates to a low calorie, palatable sugar substitute composition, which is suitable for use in the preparation of baked foods, and other prepared liquid, solid and semi-solid comestibles and food stuffs.

2. Description of the Prior Art

High intensity sweeteners (“HIS”) such as sucralose provide a means for sweetening products without introducing a caloric burden. HIS may be provided to consumers in a variety of delivery forms, but none are without their disadvantages.

One delivery form for providing a HIS to consumers is via packets, which typically contain a HIS having a sweetness equivalent of about 1 to 2 teaspoons of sucrose. However, such packets possess a number of disadvantages. Because very little amount of HIS is actually needed to provide the sweetness equivalence of 1 to 2 teaspoons of sucrose, the HIS may be left within the packet and thereby significantly affect the sweetness level of the dispensed product. Although the significance of this error can be reduced by diluting the HIS with about 50 to 100 times of a bulking material, such as a carbohydrate, such an addition disadvantageously increases the caloric content of the resulting product. Furthermore, in the event that the user desires to “customize a dose” by using, for example, a packet and a half of sweetener, it is often difficult to repeat such dose with certainty. Additionally, there is no simple way of storing an opened packet containing HIS for future use, so the unused sweetener in the second packet is often discarded.

HIS may also be provided to consumers via a granular delivery form. Although this permits consumers to vary the dose of sweetener, a transfer device, e.g. spoon, for measuring is required. Such granular forms also require a bulking material to provide a volumetric or weight based equivalence to sucrose. However, as with the packets, such bulking material introduces caloric materials that are not desirable in the sweetened product.

Users of HIS in other delivery forms, such as tablets and cubes, also encounter similar difficulties.

Many food applications, such as unsweetened powdered soft drink mixes, are underserved by the current HIS delivery form alternatives. These mixes are designed to be combined with water and a unit quantity of sugar, which is typically a cup, by the consumer prior to consumption. The use of a cup of sugar would result in the addition of about 908 calories to the resulting drink mix.

Often consumers would prefer to use a HIS instead of sugar in order to avoid the calories and other negative health concerns that can accompany overuse of nutritive sugars. However, if the drink mix were sweetened with the typical HIS packets or sachets, such as “SPLENDA® No Calorie Sweetener” product available from MCNEIL NUTRITIONALS, LLC the consumer would have to open and add about 16 packets in order to achieve the desired sweetness. In addition to the inconvenience and waste associated with the use of this many packets, their contents would also introduce about 16 grams of unwanted carbohydrate bulk and 64 additional, un-needed calories to the resulting drink product.

If the drink mix were sweetened with a HIS in the granular form, such as “SPLENDA® No Calorie Sweetener” granular product or “SPLENDA® Sugar Blend for Baking” product, not only would a measuring device be required, but also between about 28 and 113 grams of carbohydrate and between about 112 and 454 additional, un-needed calories would be introduced to the resulting drink product.

It would be desirable to provide customizable, low calorie sugar substitute compositions to the consumer without the excessive, unwanted amount calories from carrier materials and without the need for additional measuring devices.

### SUMMARY OF THE INVENTION

The invention provides a solid, low calorie, palatable sugar substitute composition, as well as a kit and method for sweetening food products using the composition as described in the claims.

### DETAILED DESCRIPTION OF THE INVENTION

It is believed that one skilled in the art can, based upon the description herein, utilize the present invention to its fullest extent. The following specific embodiments are to be construed as merely illustrative, and not limitative of the remainder of the disclosure in any way whatsoever.

Unless defined otherwise, all technical and scientific terms used herein have the same meaning as commonly understood by one of ordinary skill in the art to which the invention belongs. Also, all publications, patent applications, patents, and other references mentioned herein are incorporated by reference. As used herein, all percentages are by weight unless otherwise specified.

As used herein, “calorie(s)” shall refer to Kcal(s).

As used herein, a gram (or other given amount) of “Sucrose Equivalent Sweetness” shall mean the amount of HIS needed to be added to an 8 ounce glass of water in order to provide the same sweetness as an independent 8 ounce glass of water containing 1 gram (or that other given amount) of sucrose. For example, 1/200 g of aspartame will equal about 1 gram of Sucrose Equivalent Sweetness because aspartame is about 200 times sweeter than sucrose. Similarly, about 1/500 g to about 1/600 g of sucralose will provide one gram of Sucrose Equivalent Sweetness because sucralose is about 500 to about 600 times sweeter than sucrose.

The low calorie, palatable sugar substitute composition of the present invention comprises, consists of, and/or consists essentially of a) a high intensity sweetener in an amount sufficient to provide greater than about 10 grams of Sucrose Equivalent Sweetness; and b) a carrier, wherein said carrier provides less than about 0.49 calories, e.g., less than about 0.4 calories or less than about 0.1 calories or less than about 0.05 calories or less than about 0.01 calories, per gram of Sucrose Equivalent Sweetness.

Examples of suitable high intensity sweeteners include, but are not limited to sucralose, aspartame, saccharin, cyclamate, neotame, alitame, acesulfame potassium; sweet proteins such as brazien; extracts of sweet plants such as stevia; and their salts and derivatives thereof; and mixtures thereof.

In one embodiment, the high intensity sweetener that is employed in the invention is sucralose, which is the compound 4,1′, 6′-trichloro-4,1′, 6′- trideoxygalactosucrose. Sucralose is especially useful in recipes that require thermal processing (baking, retorting, extrusion, etc.), because of its heat stability and high quality sensory attributes.

The amount of HIS suitable for use in the composition of the present invention may be expressed in terms of “Sucrose Equivalent Sweetness.” For example, the composition may be comprised of an amount of HIS that would provide the sweetness equivalent of 1 cup (or about 200 grams) of sucrose, or 1 liter (about 600 grams) of sucrose. Alternatively, the HIS in the composition may provide the Sucrose Equivalent Sweetness to any other amount of sucrose, such as for example unit amounts of quarts, pints, 100 grams, kilograms, pounds, and the like.

In the preparation of prepared foods (baked goods, comestibles, etc.), sucralose (or other high intensity sweetener) is often used in the recipe in the amount to provide the equivalent amount of sweetness of the sugar it replaces. For example, because sucralose is about 600 times as sweet as sugar, it may be used in approximately 1/600 the amount of sugar replaced. That is, the HIS is used in an amount to provide the Sucrose Equivalent Sweetness of at least a gram, i.e., e.g., at least 50 grams, 100 grams or 150 grams of sucrose.

In one embodiment, the amount of HIS in the composition may be customized for use in a specific food product application, such as that amount of HIS required for use in a particular cake mix, cookie mix, bread mix, brownie mix, drink mix, or cereal. This embodiment would facilitate the production and manufacture of unsweetened base food products, and would provide the consumer with the option of sweetening that food product with either a nutritive or high intensity sweetener.

The carrier component of the sweetening composition may be comprised of any material suitable for incorporation into food regardless of its specific caloric density as long as the amount used provides less than about 0.49 calories, e.g., less than about 0.4 calories or less than about 0.1 calories or less than about 0.05 calories or less than about 0.01 calories, per gram of Sucrose Equivalent Sweetness. In one embodiment, the carrier is a free-flowing, water soluble material, and in another embodiment the carrier may be capable of providing a low glycemic response. In another embodiment, the carrier may be a non-water soluble material. In yet another embodiment, the carrier can be a mixture of water soluble and non soluble materials. As used herein, “low glycemic response” shall mean a compound that, when ingested provides a peak insulin response which is less than the peak insulin response produced by ingesting an an equivalent amount of sucrose. The carrier may also facilitate the emptying of the HIS/carrier composition from the container or provide other benefits as disclosed in U.S. Pat. No. 6,809,198.

Examples of suitable water soluble carriers include, but are not limited to sucrose, dextrose, fructose, galactose, lactose, maltose, maltodextrose and other glucans, insulin and other fructans, polydextrose, xylans, galactans, nutritive sugar, sugar alcohols and other polyols, or combinations thereof.

Examples of suitable non-soluble carriers include celluloses such as those available from International Fiber Corporation under the tradename, “Solka Floc®;” water insoluble fractions of starches, resistant starches, and modified versions thereof; diatomaceous earth; lignins of various plants such as, for example, corn or trees such as larch; complex aromatic polymers and co-polymers formed from coumaryl, guaiacyl, coniferyl, or sinapyl alcohols; water insoluble hemicelluloses; water insoluble portions of amylose or amylose pectin; water insoluble fiber from plants such as, for example, nuts, oats, wheat, rice, barley, corn, or bamboo; fibers from fruits such as apples; and water insoluble fiber from vegetables such as peas, or combinations thereof.

In preparing table sugar substitute (to be used in, for example, home baked goods, on cereals and fruits, and in other foods to replace sugar), the high intensity sweetener/carrier composition can be produced by dry mixing, co-spray drying, co-freeze drying, agglomerization, blending, co-drying, extrusion, panning, serial blending, compaction, or by any other convenient process. The primary consideration is that the sweetness delivery needs to be uniform.

When the high intensity sweetener is not sucralose, the sugar substitute composition can be made by analogous procedures using similar considerations (such as the degree of sweetness of the high intensity sweetener compared with sucrose).

The HIS/carrier composition of the present invention may be packaged in a container that ideally may be comprised of a material that maintains the moisture content of the HIS/carrier composition during shipping such that the it does not change its handling characteristics. In one embodiment, the container may be comprised of a material that maintains the moisture content of the HIS/carrier composition during shipping and handling to between about 0.5 to about 10 percent by weight. The greater the moisture impermeability of the material, the more moisture will be retained within the container and the greater the stability of the product. In embodiments wherein the HIS is sucralose, the container may have a moisture vapor transfer rate (MVTR) of not more than about 0.25 gram water/100 square inches of surface area/24 hours, e.g., not more than 0.2 grams/100 square inches/24 hours or not more than 0.15 grams/100 square inches/24 hours or not more than 0.1 grams/100 square inches/24 hours, when tested at 38° C. at 92 percent relative humidity.

In another embodiment, the container may further be comprised of a material that protects the contents from other environmental conditions that may affect the contents' stability and quality such as odors and other atmospheric contaminants.

One skilled in the art would readily appreciate without undue experimentation the types of materials suitable for making the container, which may include, but are not limited to moisture limiting packaging such as metallized or aluminum foil laminated substrates such as a polymer films or a kraft paper. Suitable polymers include but are not limited to polyolefins (such as high-density (linear) polyethylene, polypropylene, etc.), polyesters (such as polyalkyl terephthalates e.g. polyethylene terephthalate, polycyclohexane-1,4-dimethylene terephthalate, polybutylene terephthalate, etc.), polyvinyl chloride, polyvinyl fluoride, and copolymers of polyvinyl chloride and polyvinyl fluoride.

The HIS/carrier composition of the present invention may be packaged in a container that preferably does not require any tools or secondary devices to open. For example, the container may be opened by tearing the paper or by removing a cap or lid as appropriate. The container may be flexible or rigid. Examples of suitable container formats include but are not limited to packets, sachets, pouches, tubs, jars, bags, and the like. In one embodiment, the container may be further packaged in a multi-container package. In another embodiment, the container may be overwrapped with a secondary packaging materials, such as various plastic and polymer films well known to those skill in the art, cardboard box, and the like. In another embodiment, the container may have hanging means, including but not limited to holes, hooks, flaps, and the like, that are designed to permit the container to hang from pegs or clips on a store wall.

Additional formats for the container include, but are not limited to, multi-walled paper bags having a suitable moisture barrier, fiber drums having polymeric or aluminum foil linings integral with the drum wall or loose liners inserts. Rigid containers such as blow molded drums and pails made of polymers with moisture barriers may also be used. The container may be a flexible package such as a shipping bag made of a polymer substrate. In one embodiment, the bag may be made from aluminum foil laminated to polymer films formed from polymers that are commonly used to make moisture resistant packaging (e.g. laminates of aluminum foil with polyolefins, polyesters, styrenics or copolymers thereof).

The carrier/high intensity sweetener composition may be used in the preparation of baked goods and other solid or semi-solid comestibles (i.e., excluding soft drinks, fruit drinks, and other liquids) in an amount such that the caloric content of the comestible is significantly less than the corresponding comestible made with sugar, i.e., e.g., from about 5% fewer calories up to a one-third or more reduction in calories, and also significantly less than the HIS that is in commercially available delivery forms, e.g., packets or granular form.

The recipes shown below illustrate the use of the sucralose/carrier composition of the present invention in the preparation of drinks. An important objective of the present invention is the direct replacement of sugar in some convenient weight or volume measure in such a manner as to require minimal or no modification of the commercial or home-use recipes, as well as no tools for opening the container. This is a key consideration from the standpoint of ease of use, and one in which other commercially available HIS have traditionally been less than successful.

Another objective of the present invention is to provide such a carrier/HIS composition without introducing additional, unwanted carbohydrates and calories currently associated with nutritive and commercially available high intensity sweeteners while simultaneously not increasing the variance of sweetness delivered to the consumer resulting from, for example, retention of sweetener in packets Surprisingly, the sugar substitute composition of the present invention yielded satisfactory comestible drink products of good quality relative to sugar control despite the use of a lesser amount of carrier. More specifically, the versatility of the present invention can be demonstrated by the preparation of not only drinks, but also a variety of baked goods, and the like using the present sugar substitute compositions as the sweetener. Advantageously, the quantity of HIS in the sweetening composition held in the container may be adjusted such that the contents are matched with the unit quantity of sweetness required in the respective base food product. The invention beneficially accomplishes this without degradating the consistency of sweetness delivered. In addition, the sweetening composition of the present invention provides the consumer with a convenient way to sweeten a base food product, e.g. drink mix or baking mix, because only one container, e.g. a single packet, needs to be opened.

The following examples further illustrate the invention.

### EXAMPLES

### Example 1

### Method of Producing Sucralose/Carrier Composition

A composition comprised of sucralose and an agglomerated dextrose carrier may be produced as follows:

750 pounds of dextrose, which is commercially available from Corn Products Company under the tradename, “Unidex,” are charged into a 50 cu. Ft. Patterson Kelly twin shell blender equipped with a 4-bladed high speed intensifier bar. 22 pounds of sucralose, which is commercially available from Tate & Lyle under the tradename, “SPLENDA® Sucralose” is then added thereto. 1088 additional pounds of dextrose are then added to the mixture. The resulting mixture is then blended under ambient temperature conditions.

After about 2 minutes of blending, the intensity bar is activated to a speed of about 3300 fpm while the mixture continues to be blended at a rate of about 13-14 rpm for an additional 20 minutes.

The resulting composition is suitable for subsequent packaging in standard packets.

### Example 2

### Method of Producing Sucralose/Carrier Composition

A composition comprised of sucralose and an agglomerated dextrose carrier may be produced as follows:

750 pounds of dextrose, which is commercially available from Corn Products Company under the trade name, “Unidex,” are charged into a 50 cu. Ft. Patterson Kelly twin shell blender equipped with a 4-bladed high speed intensifier bar. 733 pounds of sucralose, which is commercially available from Tate & Lyle under the tradename, “SPLENDA® Sucralose,” are then added thereto. 377 additional pounds of dextrose are then added to the mixture. The resulting mixture is then blended under ambient temperature conditions.

After about 2 minutes of blending, the intensity bar is activated to a speed of about 3300 fpm while the mixture continues to be blended at a rate of about 13-14 rpm for an additional 20 minutes.

The resulting composition is suitable for subsequent packaging in packets having 1 cup of Sucrose Equivalent Sweetness.

### Example 3

### Method of Sweetening a Dry Drink Mix Product

About 1 cup (200 grams) of sucrose, which is commercially available from Domino, Inc. under the tradename, “Domino Granular Sugar,” was added to a container containing 2 quarts of water. A packet of KOOL-AID ® brand unsweetened drink mix was then added thereto with stirring.

The total caloric content of the cup of sucrose was about 800 calories.

The calorie contribution of the sucrose per drink serving was about 100 calorie/serving, or about 4 calories/gram of Sucrose Equivalent Sweetness.

### Example 4

### Method of Sweetening a Dry Drink Mix Product

About 0.6 grams of sucralose were blended with about 0.6 grams of a short chain fructo-oligosaccharide commercially available from GTC Nutrition, LLC under the tradename, “NUTRAFLORA,” in a one cup container and mixed by hand for about 1 minutes. The resulting mixture was placed into a packet, then heat sealed. The packet was comprised of a paper coated with polyethylene, and was commercially available from Jencoat under the tradename, “24/5.” The overall caloric content of the mixture in the packet was about 0.9 calories. The sucralose mixture also possessed about 1 cup (or 200 grams) of Sucrose Equivalent Sweetness.

The contents of the packet were then added to a container containing 2 quarts of water. A packet of KOOL-AID ® brand unsweetened drink mix was then added thereto with stirring.

The calorie contribution of the sucralose mixture per 8 oz. drink serving was about 0.1 Calorie/serving, or about 0.005 calories/gram of Sucrose Equivalent Sweetness.

This Example showed that the caloric content of each serving of drink mix was reduced by about 89 percent when using the sucralose mixture instead of sucrose as the sweetener.

### Example 5

### Comparative Taste Test

In a blind taste test, three panelists were independently asked to taste the sucrose-containing drink of Example 3 and the sucralose-containing drink of Example 4 and to compare the sweetness level in both drinks. All panelists reported that both drinks possessed substantially identical sweetness.

### Example 6

### Caloric Comparison of Sweeteners

The following sweeteners were analyzed for their respective caloric properties, and the results are shown below in Table A:

TABLE A
Caloric Comparison of Sweeteners

| | | | | | | | | | Calories |
|---|---|---|---|---|---|---|---|---|---|
| | | | | | | | | Total | of |
| | Serving | | Calories | | | Calories | Calories | Calories | Product |
| | Size (tsp) | Grams of | Equivalent | Grams of | Grams of | from | from | (Calories) | (Calorie) |
| Sweetener | of | SES* in | in Product | Sweetener | Carrier in | Carrier | Sweetener | of | per Gram |
| Product | Product | Product | (Calorie) | in Product | Product | (Calorie) | (Calorie) | Product | SES |
| EQUAL | 1 | 4 | 16 | 0.02 | 0.48 | 1.91 | 0.18 | 2.09 | 0.52 |
| Spoonful** | | | | | | | | | |
| EQUAL | 2 | 8 | 32 | 0.04 | 0.96 | 3.82 | 0.36 | 4.18 | 0.52 |
| packets** | | | | | | | | | |
| SPLENDA ® | 2 | 8 | 32 | 0.02 | 0.98 | 3.94 | — | 0.49 | 0.49 |
| No Calorie | | | | | | | | | |
| Sweetener | | | | | | | | | |
| packet*** | | | | | | | | | |
| SPLENDA ® | 1 | 4 | 16 | 0.01 | 0.49 | 1.97 | — | 1.97 | 0.49 |
| No Calorie | | | | | | | | | |
| Sweetener | | | | | | | | | |
| granular*** | | | | | | | | | |
| SPLENDA ® | 1 | 4 | 16 | 0.01 | 1.992 | 7.97 | — | 7.97 | 1.99 |
| Sugar | | | | | | | | | |
| Blend for | | | | | | | | | |
| Baking*** | | | | | | | | | |
| Sucrose | 1 | 4 | 16 | 4.00 | — | — | 16 | 16.00 | 4.00 |
| sugar | | | | | | | | | |

“SES” is Sucralose Equivalent Sweetness
**commercially available from Merisant Corporation
***commercially available from McNEIL Nutritionals, LLC.

This Example showed that although the calories per Sucrose Equivalent Sweetness of commercially available high intensity sweetener products were significantly less than that possessed by sucrose, such high intensity sweetener products still possessed at least about 0.49 calories per gram of Sucrose Equivalent Sweetness.

### Example 7

### Comparison of Delivery Variance

Table B shows a comparison of various HIS/carrier compositions provided by this invention with a standard packet formulation. “Packet Retention,” shall mean the amount of composition that remains in the packet after a user attempts to empty the majority of its contents therefrom. “Sweetener Delivery” shall mean the amount of sweetener that is emptied from the packet after a user attempts to empty the majority of its contents therefrom. “Variance in Sweetener Delivery” shall mean the difference between the high and low amount of sweetener delivered. “Sweetener Variance (%)” may be calculated by dividing the Variance in Sweetener Delivery by the low amount of sweetener delivered.

This chart illustrates how the compositions of the present invention differ from those commercially available HIS composition not only by providing a reduction on the energy delivered but by maintaining a low delivery variance. For example, by comparing the compositions of reference line 1 (0.016 g sucralose/0.984 g carrier, which has a sweetness of 2 teaspoons SES) and reference line 5 (0.4000 g sucralose/0.615 g carrier, which has a sweetness of 1 cup SES), it can be seen that both composition effective provide a 5% delivery variance. However, by providing the sweetener in a 1 cup SES delivery form as in the reference 5 composition as opposed to using multiple 2 teaspoon packets of the reference 1 composition, the energy delivery is reduced from 0.490 kilocalories per gram SES to 0.012 kilocalories per gram SES.

Those skilled in the art will understand that the 5% level in Sweetener Variance is chosen for the analysis because this is the level at which most consumers can begin to perceive differences in sweetness levels. Those skilled in the art will also appreciate that changes in packaging equipment may somewhat change the Sweetener Variance, but will not affect the general principle described. Further, while the invention heretofore describes the Sweetener Varience as being caused by emptying variance it will now be clear to those skilled in the art that the present invention shall also overcome the variances associated with filling variances.

TABLE B

| | | | | | | Energy | | | | Sweetener | | | |
|---|---|---|---|---|---|---|---|---|---|---|---|---|---|
| | | | | | | per | | Packet | | Delivery | | | |
| | | | Sucralose | | | gram | | Retention | | | | Variance | |
| | | | | grams | Carrier* | SES | Total | Low | High | Low | High | | per- |
| Ref. | Case | | grams | SES | gram | Kcal | grams | grams | grams | grams | grams | grams | cent |
| 1 | 2 | teaspoons SES | 0.0160 | 8 | 0.984 | 0.492 | 1 | 0.001 | 0.051 | 0.0160 | 0.0152 | 0.0008 | 5.00% |
| 1 | 2 | teaspoons SES | 0.0160 | 8 | 0.984 | 0.492 | 1 | 0.001 | 0.051 | 0.0160 | 0.0152 | 0.0008 | 5.00% |
| 2 | 2 | teaspoons SES | 0.0160 | 8 | 0.500 | 0.250 | 0.516 | 0.001 | 0.052 | 0.0160 | 0.0144 | 0.0016 | 9.84% |
| 3 | 2 | teaspoons SES | 0.0160 | 8 | 0.000 | 0.000 | 0.016 | 0.001 | 0.052 | n/a | n/a | n/a | >100% |
| 1 | 2 | teaspoons SES | 0.0160 | 8 | 0.984 | 0.492 | 1 | 0.001 | 0.051 | 0.0160 | 0.0152 | 0.0008 | 5.00% |
| 4 | 10 | grams SES | 0.0200 | 10 | 0.995 | 0.398 | 1.015 | 0.001 | 0.052 | 0.0200 | 0.0190 | 0.0010 | 5.00% |
| 1 | 2 | teaspoons SES | 0.0160 | 8 | 0.984 | 0.492 | 1 | 0.001 | 0.051 | 0.0160 | 0.0152 | 0.0008 | 5.00% |
| 5 | 1 | cup SES | 0.4000 | 200 | 0.615 | 0.012 | 1.015 | 0.001 | 0.052 | 0.3996 | 0.3796 | 0.0200 | 5.00% |
| 6 | 1 | cup SES | 0.4000 | 200 | 0.000 | 0.000 | 0.4 | 0.001 | 0.052 | 0.3990 | 0.3482 | 0.0508 | 12.70% |
| 1 | 2 | teaspoons SES | 0.0160 | 8 | 0.984 | 0.492 | 1 | 0.001 | 0.051 | 0.0160 | 0.0152 | 0.0008 | 5.00% |
| 7 | ½ | cup SES | 0.2000 | 100 | 0.815 | 0.033 | 1.015 | 0.001 | 0.052 | 0.1998 | 0.1898 | 0.0100 | 5.00% |
| 8 | ½ | cup SES | 0.2000 | 100 | 0.000 | 0.000 | 0.2 | 0.001 | 0.052 | 0.1990 | 0.1482 | 0.0508 | 25.40% |
| 1 | 2 | teaspoons SES | 0.0160 | 8 | 0.984 | 0.492 | 1 | 0.001 | 0.051 | 0.0160 | 0.0152 | 0.0008 | 5.00% |
| 9 | 1 | lb SES | 0.9080 | 454 | 0.109 | 0.001 | 1.017 | 0.001 | 0.052 | 0.9071 | 0.8618 | 0.0454 | 5.00% |
| 10 | 2 | lb SES | 0.9080 | 454 | 0.000 | 0.000 | 0.908 | 1.001 | 1.052 | −0.0930 | −0.1438 | 0.0508 | 5.59% |
| 1 | 2 | teaspoons SES | 0.0160 | 8 | 0.984 | 0.492 | 1 | 0.001 | 0.051 | 0.0160 | 0.0152 | 0.0008 | 5.00% |
| 11 | 1 | kg SES | 2.0000 | 1000 | 0.000 | 0.000 | 2 | 0.001 | 0.052 | 1.9990 | 1.9482 | 0.0508 | 2.54% |
| 1 | 2 | teaspoons SES | 0.0160 | 8 | 0.984 | 0.492 | 1 | 0.001 | 0.051 | 0.0160 | 0.0152 | 0.0008 | 5.00% |
| 12 | 50 | grams | 0.1000 | 50 | 0.915 | 0.073 | 1.015 | 0.001 | 0.052 | 0.0999 | 0.0949 | 0.0050 | 5.00% |
| 1 | 2 | teaspoons SES | 0.0160 | 8 | 0.984 | 0.492 | 1 | 0.001 | 0.051 | 0.0160 | 0.0152 | 0.0008 | 5.00% |
| 13 | 1 | quart SES | 1.6000 | 800 | 0.000 | 0.000 | 1.6 | 0.001 | 0.052 | 1.5990 | 1.5482 | 0.0508 | 3.18% |

*Carrier is the Unidex dextrose of Example 1.

Table C illustrates the fact that when the Sweetness Variance is cut in half by means of a reduction in packet retention, a one-cup delivery provides a 41× reduction in calories delivered per SES than the caloric amount of a commercially available, 2 teaspoon HIS packets, which are typically those found at retailers and in restaurants.

TABLE C

| | | | | | Energy | | Packet | | Sweetener | | | |
|---|---|---|---|---|---|---|---|---|---|---|---|---|
| | | | | | per gram | | Retention | | Delivery | | | |
| | | Sucralose | | Carrier | SES | Total | Low | High | Low | High | Varience | |
| Ref. | Case | grams | grams SES | gram | calories | grams | grams | grams | grams | grams | grams | percent |
| 1 | 2 teaspoons SES | 0.0160 | 8 | 0.984 | 0.492 | 1 | 0.001 | 0.026 | 0.0160 | 0.0156 | 0.0004 | 2.50% |
| 1 | 2 teaspoons SES | 0.0160 | 8 | 0.984 | 0.492 | 1 | 0.001 | 0.026 | 0.0160 | 0.0156 | 0.0004 | 2.50% |
| 5 | 1 cup SES | 0.4000 | 200 | 0.600 | 0.012 | 1 | 0.001 | 0.026 | 0.3996 | 0.3896 | 0.0100 | 2.50% |
| 6 | 1 cup SES | 0.4000 | 200 | 0.000 | 0.000 | 0.4 | 0.001 | 0.026 | 0.3990 | 0.3740 | 0.0250 | 6.25% |

### Example 8

### Delivery Variance of Standard, Two Teaspoon Packets

10 packets available from McNEIL Nutritionals, LLC. under the tradename, “SPLENDA® No Calorie Sweetener,” were sequentially opened and poured into a tarred cup on a Metier PJ360 Duel Range Scale. The cup was emptied and re-tarred prior to adding the contents of each packet. The packets were opened and dumped into the cup in a manner replicating that of a consumer who was dumping a packet into a cup of coffee. The person who opened the packets did not exert any extra effort to assure that all material was emptied from the packets.

Table D shows typical delivery variance associated with standard packets demonstrating typical Sweetener Variance. These results indicated an average delivery of 0.971 g per packet, with a standard deviation of 0.030.

TABLE D
Delivery Variance with Packets

| Packet | Weight |
|---|---|
| Number | Delivered |
| 1 | 1.001 |
| 2 | 0.969 |
| 3 | 0.904 |
| 4 | 0.965 |
| 5 | 0.996 |
| 6 | 0.945 |
| 7 | 0.968 |
| 8 | 1.001 |
| 9 | 0.994 |
| 10 | 0.969 |
| average | 0.971 |
| sd | 0.030 |

What is claimed is:

1. A solid, low calorie, palatable sugar substitute composition comprising:
a) a high intensity sweetener in an amount sufficient to provide greater than about 10 grams of sucrose equivalent sweetness; and
b) a carrier,
wherein said carrier is in an amount sufficient to provide the composition with less than about 0.49 calories per gram of sucrose equivalent sweetness.

2. The solid, low calorie, palatable sugar substitute composition of claim 1, wherein the high intensity sweetener is selected from the group consisting of sucralose, aspartame, saccharin, cyclamate, neotame, alitame, acesulfame potassium; brazien; stevia extract; and their salts and derivatives thereof; and mixtures thereof.

3. The solid, low calorie, palatable sugar substitute composition of claim 1 wherein the high intensity sweetener is sucralose or a blend of sucralose with another high intensity sweetener.

4. The solid, low calorie, palatable sugar substitute composition of claim 1 wherein the high intensity sweetener is sucralose.

5. The solid, low calorie, palatable sugar substitute composition of claim 1 wherein the high intensity sweetener is sucralose and the carrier is selected from the group consisting of dextrose, dextrose/maltodextrin blends, fructo-oligosaccharides, sugar alcohols and combinations thereof.

6. The solid, low calorie, palatable sugar substitute composition of claim 1, wherein the high intensity sweetener is in an amount sufficient to provide greater than about 50 grams of sucrose equivalent sweetness.

7. The solid, low calorie, palatable sugar substitute composition of claim 1, wherein the high intensity sweetener is in an amount sufficient to provide greater than about 100 grams of sucrose equivalent sweetness.

8. The solid, low calorie, palatable sugar substitute composition of claim 1, wherein the high intensity sweetener is in an amount sufficient to provide greater than about 150 grams of sucrose equivalent sweetness.

9. The solid, low calorie, palatable sugar substitute composition of claim 1, wherein said carrier is in an amount sufficient to provide the composition with less than about 0.1 calories per gram of sucrose equivalent sweetness.

10. The solid, low calorie, palatable sugar substitute composition of claim 1, wherein said carrier is in an amount sufficient to provide the composition with less than about 0.05 calories per gram of sucrose equivalent sweetness.

11. The solid, low calorie, palatable sugar substitute composition of claim 1, wherein said carrier is in an amount sufficient to provide the composition with less than about 0.01 calories per gram of sucrose equivalent sweetness.

12. A kit for sweetening food products comprised of:
a) a sweetening composition comprised of a high intensity sweetener in an amount sufficient to provide greater than about 10 grams of Sucrose Equivalent Sweetness; and a carrier; and
a container,
wherein said carrier is in an amount sufficient to provide the sweetening composition with less than about 0.49 calories per gram of sucrose equivalent sweetness and said sweetening composition is held within the container prior to use.

13. The kit of claim 12, wherein the sweetening composition is present in an amount to deliver about a quart of sucrose equivalent sweetness.

14. The kit of claim 12, wherein the sweetening composition is present in an amount to deliver about a cup of sucrose equivalent sweetness.

15. The kit of claim 12, wherein the sweetening composition is present in an amount to deliver about a pint of sucrose equivalent sweetness.

16. The kit of claim 12, wherein the sweetening composition is present in an amount to deliver about a pound of sucrose equivalent sweetness

17. The kit of claim 12, wherein the sweetening composition is present in an amount to deliver about a 100 grams of sucrose equivalent sweetness.

18. The kit of claim 12, wherein the sweetening composition is present in an amount to deliver about a 1 kilogram of sucrose equivalent sweetness

19. The kit of claim 12, wherein the container may be selected from the group consisting of a packet, tub, jar, and bag.

20. The kit of claim 12, wherein the container may be packaged within an outer, secondary container.

21. A method of sweetening a food product comprised of
adding a composition to the food product in an amount sufficient to sweeten the food product, wherein the composition is comprised of a high intensity sweetener in an amount sufficient to provide greater than about 10 grams of sucrose equivalent sweetness; and a carrier in an amount sufficient to provide the composition with less than about 0.49 calories per gram of sucrose equivalent sweetness.

22. A kit for making a food product comprised of:
a) a container comprised of an unsweetened food product, said unsweetened food product being substantially free of a unit quantity of sucrose; and
b) a container comprised of a sweetening composition, said composition comprised of
i) a high intensity sweetener in an amount sufficient to provide greater than about 10 grams of sucrose equivalent sweetness and provide said unit quantity of sucrose equivalent sweetness to said unsweetened food product; and
ii) a carrier in an amount sufficient to provide the sweetening composition with less than about 0.49 calories per gram of sucrose equivalent sweetness.

23. The kit of claim 22, wherein the unsweetened food product is comprised of at least one of the following: cake mix; cookie mix; bread mix; brownie mix; drink mix; or cereal.
